(19) United States
(12) Patent Application Publication
(10) Pub. No.: US 2025/0298173 A1
(43) Pub. Date: Sep. 25, 2025

(54) ELECTRONIC DEVICE WITH TEXTURED DISPLAY COVER

(71) Applicant: Apple Inc., Cupertino, CA (US)

(72) Inventors: Nithin Thomas, San Jose, CA (US); Yue Qiu, Nanjing (CN); Scott J. McEuen, Cupertino, CA (US); Willie M. Reese, Oakland, CA (US); Napthaneal Y. Tan, Los Gatos, CA (US); Jeffrey L. Yen, Fremont, CA (US); Tyler R. Roschuk, San Jose, CA (US)

(21) Appl. No.: 19/060,489

(22) Filed: Feb. 21, 2025

Related U.S. Application Data
(60) Provisional application No. 63/567,932, filed on Mar. 20, 2024.
(60) Provisional application No. 63/638,305, filed on Apr. 24, 2024.

(51) Int. Cl. G02B 5/02; G02B 1/115; G02B 1/18; G06F 1/16

(52) U.S. Cl. CPC G02B 5/0221; G02B 1/115; G02B 1/18; G02B 5/0242; G06F 1/1629; G06F 1/1643

(57) ABSTRACT

An electronic device that includes a textured cover is disclosed. The textured cover may be positioned over a display assembly of the electronic device and provide an anti-glare effect while maintaining acceptable levels of readability of graphic output from the display assembly. The textured cover may also be suitable for use with an electronic stylus that provides input to the electronic device.

### CROSS-REFERENCE TO RELATED APPLICATION(S)

This application is a nonprovisional application of and claims the benefit of U.S. Provisional Patent Application No. 63/638,305, filed Apr. 24, 2024 and titled “Electronic Device With Textured Display Cover,” and U.S. Provisional Patent Application No. 63/567,932, filed Mar. 20, 2024 and titled “Electronic Device With Textured Display Cover,” the disclosures of which are hereby incorporated herein by reference in their entireties.

### FIELD

The described embodiments relate generally to an electronic device that includes a textured cover. More particularly, the present embodiments relate to an electronic device that includes a textured display cover that maintains readability of output from the display while providing an anti-glare effect.

### BACKGROUND

Electronic devices such as computing devices may include a transparent cover over a display. However, it may be difficult to see the display of some conventional electronic devices under bright lighting conditions, such as outdoor conditions.

The electronic devices disclosed herein may provide some advantages compared to some conventional electronic devices with respect to readability of the display in bright lighting conditions and/or compatibility of the electronic device with an accessory input device.

### SUMMARY

The disclosure provides an electronic device that includes a textured cover for a display assembly or another optical component. The textured cover may be configured to provide a balance of optical properties. For example, the textured cover may provide an anti-glare effect while the electronic device maintains acceptable levels of readability from a display assembly. In embodiments where the surface texture is provided over a sensor assembly as well as a display assembly, the textured cover may be configured to provide a balance between an anti-glare effect, acceptable readability levels from the display, and acceptable levels of transmission of optical signals to and from the sensor.

In embodiments, the optical properties of the textured cover are balanced against one or more other properties of the cover, including, but not limited to, compatibility of the textured cover with an object such as an electronic stylus or the ability to clean the textured cover to remove oil and dust. For example, a surface texture configured to produce a higher anti-glare effect may produce a grippier surface for touch and/or stylus input but may produce more wear of the stylus or another object that contacts the textured surface and/or have a greater tendency to trap dust, oil, and the like.

The surface texture of the display cover may produce an anti-glare effect by diffusively reflecting light from the textured cover. The textured cover may include an anti-reflection coating to reduce the total amount of light reflected from the textured cover. In some examples, a balance of optical properties may be achieved when 20% to 55% of the light reflected from the textured cover is diffusively reflected.

The anti-glare effect may be achieved without unduly decreasing readability of the display. In some cases, the antiglare effect is achieved without causing an undue sparkle effect. As examples, the amount of sparkle may be less than 10% or less than or equal to 5%. As discussed in more detail below, the sparkle effect may be affected by the pixel element configuration of the display assembly and may be more noticeable for smaller subpixel sizes. Alternately or additionally, the antiglare effect is achieved without causing undue loss of sharpness of an image or other output from the display. For example, the diffusion of light of light transmitted through the cover may be limited so that an image sharpness value is greater than 20% and less than 70% or greater than 20% and less than 60%. Furthermore, the antiglare effect may be achieved without causing an undue “milky” effect.

The disclosure provides an electronic device comprising a housing, a display assembly positioned at least partially within the housing and comprising an array of pixel elements and a sparkle reduction structure, and a cover coupled to the housing and comprising a cover member defining a textured region positioned over the display assembly, a multilayer anti-reflection coating disposed over the textured region of the cover member, an oleophobic coating bonded to the multilayer anti-reflection coating, the cover configured to produce diffusion of reflected light and a sparkle value of less than 10% for transmitted light.

In addition, the disclosure provides an electronic device comprising a housing, a display assembly comprising a touch-sensitive component configured to detect a finger touch and an active stylus touch, and a cover configured to provide an anti-glare effect and comprising a cover member defining a textured region positioned over the display assembly and contributing to the anti-glare effect, an anti-reflection coating disposed over the textured region of the cover member, and an oleophobic coating disposed over the anti-reflection coating.

The disclosure also provides an electronic device comprising a display assembly comprising an array of pixel elements, a camera assembly, and a cover comprising a cover member, an anti-reflection coating disposed over the cover member, and an oleophobic coating disposed over the anti-reflection coating, the cover further comprising a first portion defining a first surface texture positioned over the display assembly, the first portion comprising a first region of the cover member, a first region of the anti-reflection coating, and a first region of the oleophobic coating, the first surface texture having a first root mean square height (Sq) in a range from 0.14 micrometers to 0.30 micrometers and a root mean square gradient (Sdq) in a range from a range from 0.02 to 0.40, the electronic device having an image sharpness value greater than 20% and less than 70% as measured through the first surface texture and a second portion of the cover at least partially surrounding the first portion of the cover, positioned over the camera assembly, and defining a second surface texture having a second root mean square height less than the first root mean square height, the second portion comprising a second region of the cover member, a second region of the anti-reflection coating, and a second region of the oleophobic coating.

### BRIEF DESCRIPTION OF THE DRAWINGS

The disclosure will be readily understood by the following detailed description in conjunction with the accompanying drawings, wherein like reference numerals designate like elements.

FIG. 1 shows an example electronic device.

FIG. 2A shows a front view of another example electronic device.

FIG. 2B shows a rear view of the electronic device of FIG. 2A.

FIG. 3 shows a view of another example electronic device.

FIG. 4 shows a partial cross-sectional view of an example electronic device.

FIG. 5 shows an enlarged partial cross-sectional view of a cover for an example electronic device.

FIG. 6 shows another partial cross-sectional view of an example electronic device.

FIG. 7 shows another partial cross-sectional view of an example electronic device.

FIG. 8A shows a top view of a pixel element including a set of subpixels.

FIG. 8B shows another top view of a pixel element including a set of subpixels.

FIG. 9 shows a simplified example of passage of light from pixel elements of a display assembly into a textured cover of an electronic device.

FIG. 10 shows another simplified example of passage of light from pixel elements of a display assembly into a textured cover of an electronic device.

FIG. 11A shows an example image of a luminance distribution observed for a textured cover of an electronic device.

FIG. 11B shows another example image of a luminance distribution observed for a textured cover of an electronic device.

FIG. 12 shows an example block diagram of components of an electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

The disclosure provides an electronic device that includes a textured cover for a display assembly or another optical component. The textured cover may be configured to provide a balance of optical properties. For example, the textured cover may provide an anti-glare effect while the electronic device maintains acceptable levels of readability from a display assembly. In embodiments where the surface texture is provided over a sensor assembly as well as a display assembly, the textured cover may be configured to provide a balance between an anti-glare effect, acceptable readability levels from the display, and acceptable levels of transmission of optical signals to and from the sensor.

In embodiments, the optical properties of the textured cover are balanced against one or more other properties of the cover, including, but not limited to, compatibility of the textured cover with an object such as an electronic stylus or the ability to clean the textured cover to remove oil and dust. For example, a surface texture configured to produce a higher anti-glare effect may produce a grippier surface for touch and/or stylus input but may produce more wear of the stylus or another object that contacts the textured surface and/or have a greater tendency to trap dust, oil, and the like. The electronic stylus may be an active stylus rather than an inactive stylus. For example, an active stylus may emit one or more fields that are detected by a component of the display assembly (e.g., a touch-sensitive component of the display assembly).

The surface texture of the display cover may produce an anti-glare effect by diffusively reflecting light from the textured cover. The textured cover may include an anti-reflection coating to reduce the total amount of light reflected from the textured cover. In some examples, a balance of optical properties may be achieved when 20% to 55% of the light reflected from the textured cover is diffusively reflected. Alternately or additionally, an image sharpness value can be used to provide a measure of diffusion of light that is transmitted through the display cover.

The anti-glare effect may be achieved without unduly decreasing readability of the display. In some cases, the antiglare effect is achieved without causing an undue sparkle effect. As examples, the amount of sparkle may be less than 10% or less than or equal to 5%. As discussed in more detail below, the sparkle effect may be affected by the pixel element configuration of the display assembly and may be more noticeable for smaller subpixel sizes. Alternately or additionally, the antiglare effect is achieved without causing undue loss of sharpness of an image or other output from the display. For example, the diffusion of light of light transmitted through the cover may be limited so that an image sharpness value is greater than 20% and less than 70% or greater than 20% and less than 60%. Furthermore, the antiglare effect may be achieved without causing an undue “milky” effect.

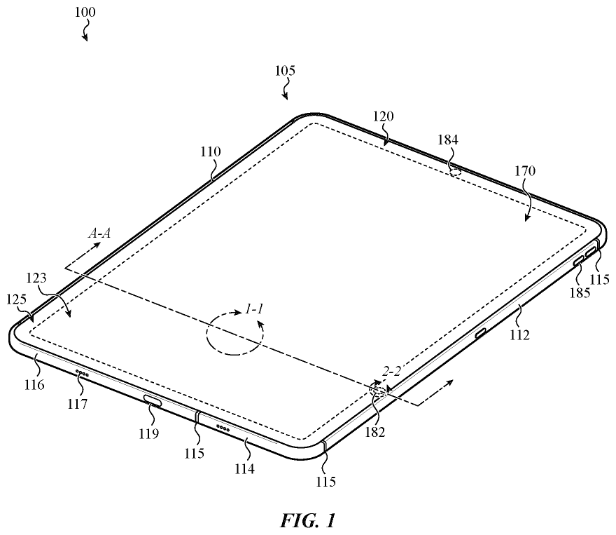

These and other embodiments are discussed below with reference to FIGS. 1-12. However, those skilled in the art will readily appreciate that the detailed description given herein with respect to these figures is for explanatory purposes only and should not be construed as limiting.

FIG. 1 shows an example electronic device 100. The electronic device of 100 of FIG. 1 may be a portable electronic device such as a tablet computer. In other examples, the electronic device may have the form of a telephone, a laptop computer, a display monitor, a wearable electronic device (e.g., a smart watch), or another form of electronic device.

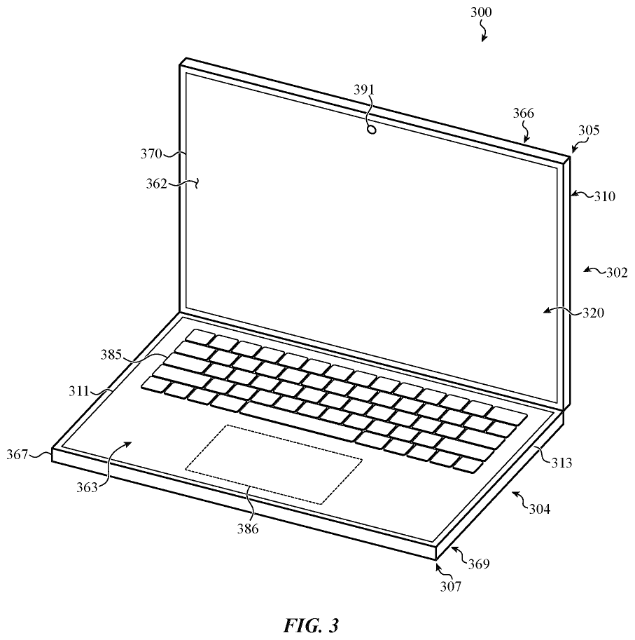

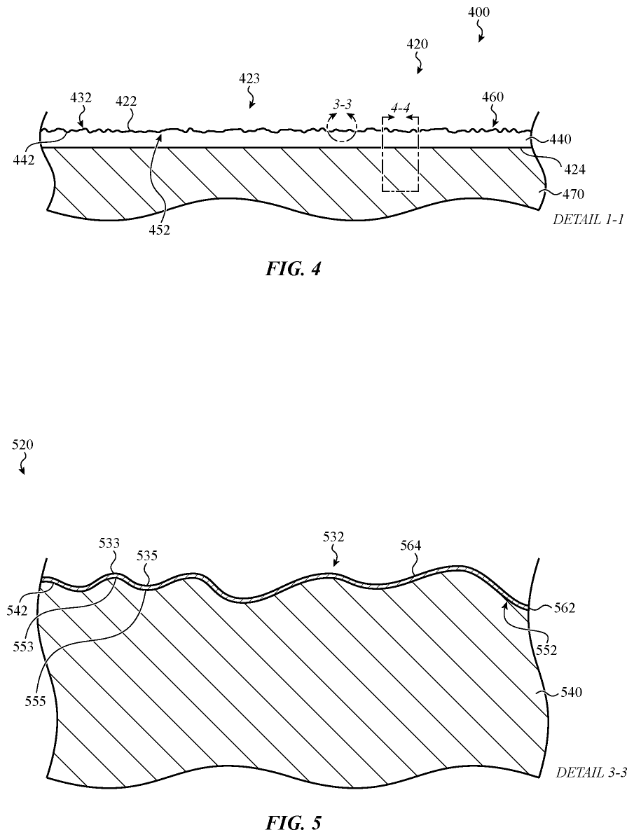

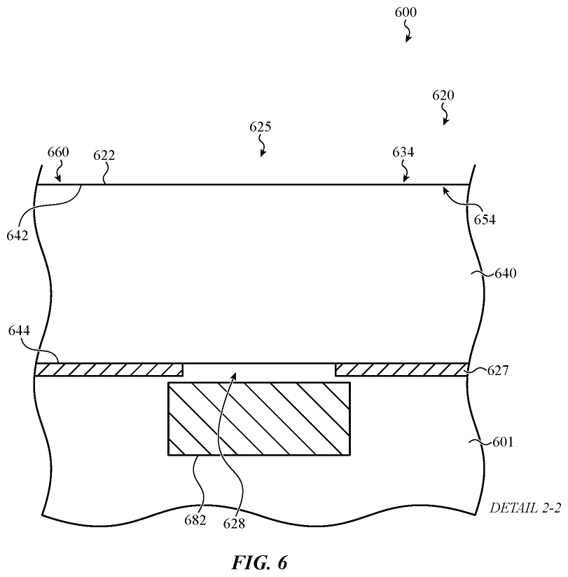

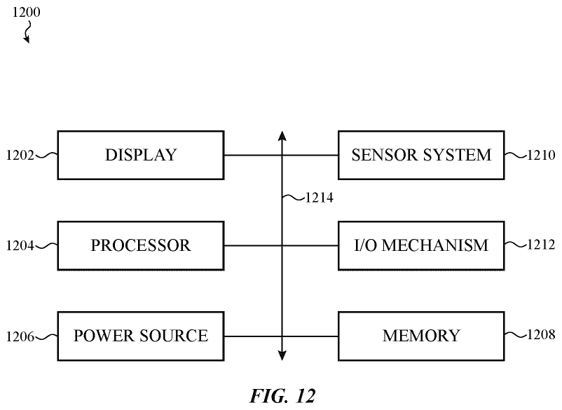

The electronic device 100 includes an enclosure 105. The enclosure 105 includes a housing 110 and a cover 120 and defines an internal cavity into which one or more device components may be placed (e.g., the internal cavity 601 of FIG. 6). In the example of FIG. 1, the electronic device includes a display assembly 170 and sensor assemblies 182 and 184. The display assembly may be configured to receive input from a user's finger and/or an electronic stylus, as discussed further with respect to FIGS. 4 and 5. More generally, the electronic device may include all or some of the device components described with respect to FIG. 12. For example, the electronic device may include one or more of a display assembly, a processor, a power source, a sensor system, an input/output mechanism, a wireless communication or charging component, or a memory. The electronic device may also include electronic circuitry operably connected to the device components.

The electronic device 100 includes a cover 120 coupled to housing 110. In the example of FIG. 1, the portion 123 of the cover 120 is positioned over the display assembly 170 and has a surface texture that produces an anti-glare effect. The portion 123 of the cover 120 may have a gloss value less than 50, such as a gloss value in a range from 15 to 30 or 15 to 25 as measured at 60 degrees. The gloss values referred to herein may refer to values in gloss units. The portion 123 of the cover 120 is alternately referred to as a first portion or as a textured portion herein. The portion 123 of the cover 120 may extend from an exterior surface to an interior surface of the cover. The example of FIG. 1 is not intended to be limiting and in other examples a substantial entirety of an exterior surface of the cover may define a surface texture that produces an anti-glare effect. The portion 123 of the cover 120 may be configured to provide a balance of optical properties, such as a balance between an anti-glare effect and readability of the display. In embodiments, the optical properties of the portion 123 of the cover 120 may be balanced against one or more other properties of the portion 123, such as compatibility with touch sensing, compatibility with objects (e.g., an electronic stylus) that contact the portion 123, or the ability to clean the portion 123 to remove oil and dust.

The cover 120 includes a cover member that defines a textured region. The cover 120 may also include a surface coating disposed over the cover member, in which case the textured region of the cover member and the surface coating together may define the surface texture of the cover 120. The cover member may have a thickness suited to the electronic device, and in some cases may have a thickness greater than 500 micrometers to 5 mm or from 200 micrometers to 1 mm. Examples of cover members and surface coatings are shown in the partial cross-sectional views of FIGS. 4-7.

The portion 125 of the cover 120 is positioned over sensor assemblies 182 and 184 and has a smoother texture than the portion 123. For example, the portion 125 may have a relatively smooth texture that results from an operation of forming or polishing the cover member. The optical properties of the portion 125 may be more compatible with the sensor assemblies 182 and 184. In some embodiments, each of the sensor assemblies 182 and 184 is an optical sensor assembly. Examples of optical sensor assemblies include, but are not limited to, light sensor assemblies, camera assemblies, biometric sensor assemblies, other image sensor assemblies, or assemblies including any of the optical sensors described herein. In some examples, an optical sensor assembly may operate over a visible spectrum or over an infrared spectrum. In some cases, the electronic device may include one or more sensor assemblies that operate over a visible light spectrum and one or more sensors that operate over an infrared spectrum. The number of sensor assemblies shown in FIG. 1 is exemplary rather than limiting and, in additional embodiments, an electronic device may include a greater or lesser number of sensor assemblies positioned under the portion 125 of the cover. The relatively smooth texture of the portion 125 may produce a glossy effect. For example, the portion 125 of the cover 120 may have a gloss value greater than 100, such as a gloss value in a range from 125 to 155 as measured at 60 degrees. The portion 125 of the cover 120 is alternately referred to as a second portion herein. The portion 125 of the cover 120 may extend from an exterior surface to an interior surface of the cover. The portion 125 may encircle (alternately, fully surround) the portion 123 of the cover 120 to define a border of the cover 120.

In some embodiments, the portion 125 of the cover 120 includes an interior coating that masks at least a portion of an interior of the electronic device 100 from view. The interior coating may define an opening over one or more optical sensor assemblies of the electronic device. For example, the interior coating may define an opening over each of the sensor assembly 182 and the sensor assembly 184. In some cases, this interior coating extends into the portion of the portion 123 of the cover. A partial cross-sectional view of a sensor assembly and an interior coating disposed along an interior surface of a cover member is shown in the example of FIG. 6 and the additional description provided with respect to FIG. 6 is not repeated here.

In the example of FIG. 1, the housing 110 is formed from multiple members, such as the members 112, 114, and 116. In some embodiments, the members 112, 114, and 116 are metal members that are separated by dielectric members 115 (e.g., polymer or polymer composite members). The dielectric members can provide electrical isolation between adjacent metal members. One or more of the metal members may be coupled to internal circuitry of the electronic device 100 and may function as an antenna for sending and receiving wireless communication. The configuration of the members 112, 114, 115, and 116 are not limited to the example of FIG. 1 and the configuration may be adjusted to provide suitable antenna function for the device 100.

As shown in the example of FIG. 1, the housing 110 includes an input device 185, which may be a push button, a touch-activated button, or the like. The example of FIG. 1 is not limiting and in other examples, the input device may be a dial, a crown, a wheel, or the like. The housing 110 of FIG. 1 also defines openings to facilitate input to the electronic device. The openings 117 may allow input to a microphone and/or may allow output from a speaker. The opening 119 may define a port.

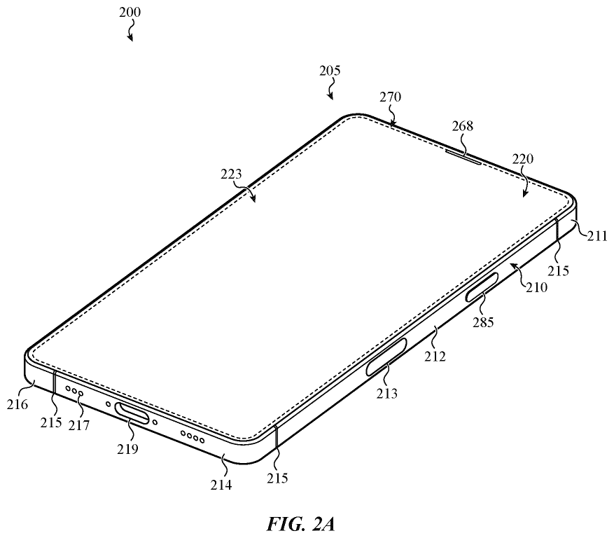

FIG. 2A shows a front view and FIG. 2B shows a rear view of another example electronic device 200. The electronic device 200 may be a mobile telephone (also referred to as a mobile phone).

The electronic device 200 includes an enclosure 205. The enclosure 205 includes a housing 210, a front cover 220, and a rear cover 221. As previously discussed with respect to FIG. 1, the enclosure 205 defines an internal cavity into which one or more device components is placed. The electronic device 200 includes a display assembly 270 and a rear sensor assembly 289. The electronic device may also include one or more front sensor assemblies, such as a front-facing camera and/or a front-facing biometric sensor, and/or any of the other device components described with respect to FIG. 12.

As shown in the example FIG. 2A, the front cover 220 includes a textured portion 223 that is positioned over the display assembly 270 and that produces an anti-glare effect. The textured portion 223 of the front cover 220 may be similar to the portion 123 of the cover 120 and that description is not repeated here. In some embodiments, the cover 220 may also include a portion similar to the portion 125 of the cover 120 that has a smoother texture than the textured portion 223 and that has optical properties that are more compatible with a front-facing optical sensor assembly, such as a light sensor assembly, an image sensor of a camera assembly or other sensor assembly, a biometric sensor assembly or any of the optical sensor assemblies described herein. The front cover 220 defines an opening 268, which may allow input to a microphone or another device component.

As shown in the example of FIG. 2B, the electronic device 200 includes a rear sensor assembly 289. The rear sensor assembly 289 includes multiple cameras 291 and 292. The rear sensor assembly also includes components 293 and 294, which may be a light source, a sensor such as a depth sensor, or any other suitable component. At least a portion of the rear sensor assembly is positioned under the rear cover 221. In the example of FIG. 2B, the rear cover defines a protruding portion 227 at the location of the rear sensor assembly 289.

The rear cover 221 may define any of a variety of surface textures. As examples, the rear cover 221 may have a texture that has a higher amplitude (alternately, height), about the same amplitude, and/or a lower amplitude than the anti-glare texture of the front cover 220. In some cases, the rear cover 221 may have a combination of surface textures.

The housing 210 of the electronic device 200 is coupled to each of the front cover 220 and the rear cover 221. The housing 210 includes input devices 285, 286, 287, and 288. In the example of FIGS. 2A and 2B, each of the input devices may be a push button, a touch-activated button, or the like. The example of FIGS. 2A and 2B is not limiting and in other examples, the electronic device 200 may include an input device in the form of a dial, a crown, a wheel, or the like. The housing 210 also includes a window 213 that may facilitate transmission of a wireless communication signal. The housing 210 also defines openings to facilitate input to the electronic device. The openings 217 may allow input to a microphone and/or may allow output from a speaker. The opening 219 may define a port.

In the example of FIGS. 2A and 2B, the housing 210 is formed from multiple members, such as the members 211, 212, 214, 216, and 218. In some embodiments, the members 211, 212, 214, 216, and 218 are metal members that are separated by dielectric members 215 (e.g., polymer or polymer composite members). The dielectric members can provide electrical isolation between adjacent metal members. One or more of the metal members may be coupled to internal circuitry of the electronic device 200 and may function as an antenna for sending and receiving wireless communication.

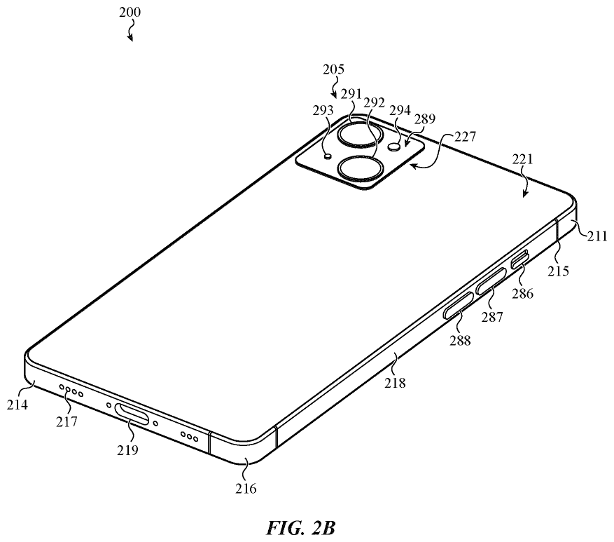

FIG. 3 shows a view of another example electronic device. The electronic device 300 may be a computing device such as a portable computer. The portable computer may be a laptop computer, a notebook computer, or the like.

In the example of FIG. 3, the electronic device 300 includes a first portion 302 and a second portion 304. The first portion 302 may be coupled to the second portion 304 through a hinge or other suitable mechanism to allow the first portion 302 to rotate, pivot, or otherwise flex with respect to the second portion 304.

The first portion 302 of the electronic device 300 includes a display assembly 370 and a camera assembly 391. The first portion 302 includes a first enclosure 305 and the display assembly 370 and the camera assembly 391 is positioned within the first enclosure 305. The example of FIG. 3 is not intended to be limiting and the electronic device may include additional sensors, such as additional optical sensors, as previously described with respect to FIG. 1. The first portion 302 may alternately be referred to herein as a display portion of the electronic device 300.

The first enclosure 305 includes a cover 320 coupled to a housing 310. The cover 320 defines a front surface 362 of the electronic device 300 and is positioned over the display assembly 370 and the camera assembly 391. The cover 320 and the display assembly 370 may include components and features that are similar to those of the cover 120 and the display assembly 170 and that description is not repeated here. The housing component 310 at least partially defines an exterior side surface 366 of the first enclosure 305.

The second portion 304 of the electronic device 300 includes multiple input devices. As shown in the example of FIG. 3, the input devices include a keyboard 385 and a trackpad 386. At least some of the components of the keyboard 385 and the trackpad 386 are positioned within a second enclosure 307 of the second portion 304. The second portion 304 may include all or some of the internal electronic device components described with respect to FIG. 12. For example, the electronic device may include one or more of a display assembly, a processor, a power source, a sensor system, an input/output mechanism, a wireless communication or charging component, or a memory. For example, the electronic device may include a biosensor that is configured to receive input through one more keys of the keyboard 385. The second portion 304 may alternately be referred to herein as a base portion of the electronic device 300.

The second enclosure 307 includes a top structure 311 that defines at least a portion of an upper surface 363 of the enclosure 307. In some examples, the top structure 311 defines one or more holes or openings to allow access to the keyboard 385 and/or trackpad 386. The second enclosure 307 also includes a housing component 313 that at least partially defines an exterior side surface 367 of the second enclosure 307. The housing component 313 may also at least partially define a rear surface 369 of the second enclosure 307 or the second enclosure may include an additional housing component that defines the rear surface 369.

Various components of the electronic device 300 may define any of a variety of surface textures. For example, the cover 320, the trackpad 386, and/or one or more keys of the keyboard 385 may define a textured region. In some cases, one or more of these textured regions may be similar in properties to the textured region 123. However, the textured regions of the cover 320, the trackpad 386, and/or one or more keys of the keyboard 385 need not have the same texture.

FIG. 4 shows a partial cross-sectional view of an example electronic device 400. The electronic device 400 includes a display assembly 470 and a cover 420 positioned over the display assembly. As shown in FIG. 4, a textured portion 423 of the cover 420 defines a surface texture 432 at an exterior surface 422 of the cover. The surface texture 432 may provide an anti-glare effect. The textured portion 423 of the cover 420 may extend from an exterior surface 422 to an interior surface 424 of the cover. The view of FIG. 4 may be an example of a cross-sectional view along A-A at detail 1-1 of FIG. 1, in which case the textured portion 423 does not span the cover 420.

In the example of FIG. 4, the textured portion 423 of the cover 420 includes a cover member 440 and a surface coating 460 disposed over the cover member 440. The cover member 440 defines a textured region 452 of an exterior surface 442 of the cover member 440. The cover member 440 may span the cover 420. The textured region 452 and the surface coating 460 may together define the surface texture 432 of the cover 420. Each of the surface texture 432 of the cover 420 and the textured region 452 of the cover member 440 may be characterized by one or more texture parameters. The textured region 452 may alternately be referred to as defining a surface finish and in some embodiments may be referred to as a first region of the cover member. The description of texture parameters provided with respect to FIG. 5 is generally applicable herein and is not repeated here.

In the example of FIG. 4, the cover 420 defines a transparent window for the display assembly 470. In some embodiments, the cover member 440 is a glass cover member that is formed from a silicate glass material. For example, the glass material may comprise an aluminosilicate glass or a boroaluminosilicate glass. As used herein, an aluminosilicate glass includes the elements aluminum, silicon, and oxygen, but may further include other elements. Similarly, a boroaluminosilicate glass includes the elements boron, aluminum, silicon, and oxygen, but may further include other elements. An aluminosilicate glass or a boroaluminosilicate glass may further include monovalent or divalent ions which compensate charges due to replacement of silicon ions by aluminum ions. Suitable monovalent ions include, but are not limited to, alkali metal ions such as Li⁺, Na⁺, or K⁺ and an aluminosilicate glass including alkali metal ions may be referred to herein as an alkali aluminosilicate glass. Suitable divalent ions include alkaline earth ions such as Ca²⁺ or Mg²⁺. The glass material of the glass cover member may be ion exchangeable. In other embodiments, the cover member 440 may be formed of a glass ceramic material or may have a laminate structure that includes layers of glass and/or glass ceramic.

In some embodiments, at least one surface of the cover member is chemically strengthened through ion exchange. The ion exchange may involve exchanging smaller ions in the ion-exchangeable cover member with larger ions to form an ion-exchanged layer. The ion-exchanged layer may include a compressive stress region. In some examples, ion exchanged layers and compressive stress regions are formed along both the exterior and interior surfaces of the cover member.

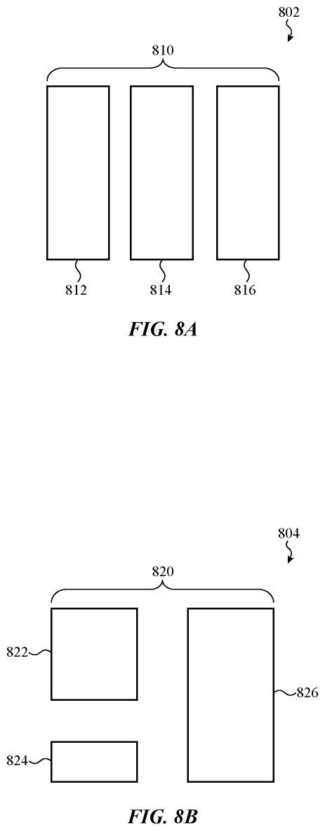

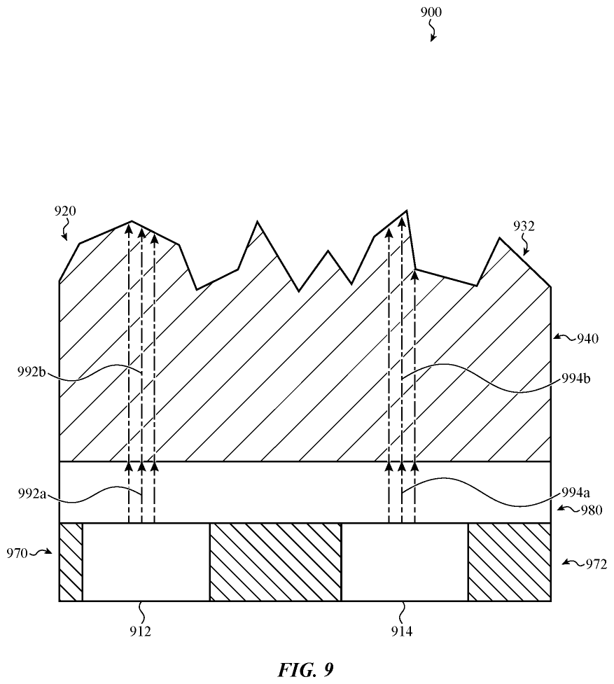

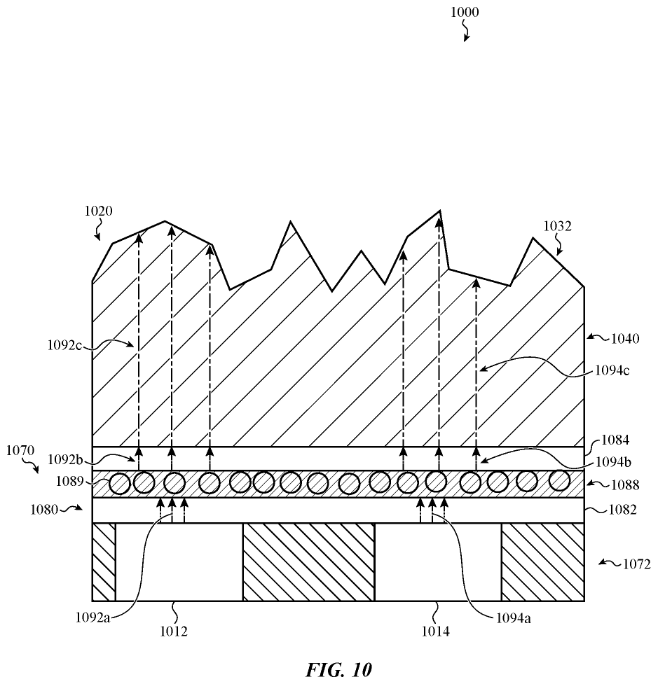

In embodiments, the display assembly 470 includes multiple components. In embodiments, the display assembly 470 includes an array of pixel elements and each pixel of the array of pixel elements includes a set of subpixels. Pixel elements may be alternately referred to as pixels herein and subpixels may alternately be referred to as subpixel elements herein. Examples of pixel element and subpixel configurations are shown in FIGS. 8A and 8B and the description provided with respect to these figures, as well the additional pixel-related description provided with respect to FIGS. 9 and 10, is not repeated here. The display assembly 470 also typically includes electronic circuitry operably connected to the pixel elements of the array. For example, the electronic circuitry may include thin film transistors (TFTs) operably connected to the pixel elements. In some embodiments, the display assembly includes a shielding layer to limit the effect of the electronic circuitry on other components of the display assembly such as the touch layer and/or on operation of an electronic stylus. In some embodiments, the display assembly is an organic light-emitting diode (OLED) display assembly or an active layer organic light-emitting diode (AMOLED) display assembly. In other embodiments, the display assembly is a liquid-crystal (LCD) assembly, a light-emitting diode (LED) display assembly, or an LED-backlit LCD display assembly.

In embodiments, the display assembly 470 includes one or more optical structures. In some cases, the display assembly includes an optical structure positioned between the array of pixel elements and the cover member and configured to reduce sparkling effects due to the surface texture 432. In these cases, the optical structure may alternately be referred to as a sparkle reduction structure. In some examples, the optical structure is configured to enlarge an optical output of at least one subpixel of the array of pixel elements, as schematically shown in the example of FIG. 10. Such an optical structure can help reduce sparkling effects when a lateral dimension (e.g., a width and/or a length) of one or more subpixels is similar to a mean spacing of peaks of the surface texture.

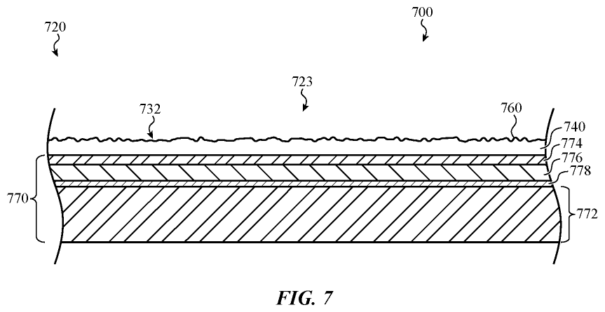

In embodiments, the display assembly 470 includes a touch-sensitive component. The touch-sensitive component may comprise a touch sensor configured to detect a touch or touch input along an exterior surface of the cover 420. The touch input may be provided by a user's finger and/or by an electronic stylus. The touch-sensitive component may be positioned between the array of pixel elements and the cover member 440. An example of a display assembly including a touch-sensitive component, an optical structure, and a shielding layer as well as an array of pixel elements is shown in the cross-sectional view of FIG. 7.

The display assembly 470 may be configured to receive input from an electronic stylus (e.g., an active stylus). For example, the touch sensitive component of the display assembly 470 may be responsive to a touch input from the electronic stylus. When the electronic stylus also transmits information about a condition of a stylus to the electronic device, this information may be provided to the touch sensor or to another component of the electronic device that is in communication with the electronic stylus. The input from the electronic stylus may influence the graphical output provided by the display.

The surface coating 460 may include an anti-reflection coating and/or an anti-smudge coating. In some examples, the surface coating 460 includes an anti-reflection coating disposed over the cover member and an anti-smudge coating disposed over the anti-reflection coating, as shown in the example of FIG. 5. When the display assembly is configured to receive input from an electronic stylus, the surface coating 460 may be configured to be sufficiently durable to be compatible with travel of a stylus tip over the surface texture 432. When the cover 420 includes an anti-glare portion and another glossier portion, the portion 423 may include a first region of the anti-reflection coating and a first region of the anti-smudge coating and the other glossier portion of the cover may include second region of the anti-reflection coating and a second region of the anti-smudge coating. As discussed below, the anti-smudge coating may be an oleophobic coating in some embodiments. The surface coating 460 may be thin relative to the amplitude (alternately, height) of the surface roughness.

The anti-reflection coating may be configured to produce destructive interference of light reflected from the textured portion 423 of the cover 420. The average combined specular and diffuse reflectance (specular component included, SCI) of the textured portion of the cover 420 may be less than 10%, less than 8%, or less than 6%. The average diffuse reflectance (specular component excluded, SCE) may be less than 8%, less than 5%, or less than 3%. These examples of reflectance vales are for a textured portion of the cover 420 with a surface coating 460 that includes an anti-reflection coating and that may include an anti-smudge coating. In contrast, a substantially smooth portion of the cover may have a phototropic reflectance less than 3%, less than 2%, or less than 1%.

The anti-reflection coating may have multiple layers. For example, the anti-reflection coating may have from 5 layers to 10 layers. Each of the layers of the anti-reflection coating may be a dielectric layer. For example, the dielectric layer may be formed from an inorganic dielectric material. In some cases, the anti-reflection coating may include one or more layers having a first index of refraction and one or more layers having a second index of refraction that is greater than the first index of refraction. In some examples, the layers having the second index of refraction are harder than the layers having the first index of refraction, which may help to increase the durability of the coating. The layers of the anti-reflection coating may be formed using a physical vapor deposition (PVD) technique.

The anti-reflection coating may include alternating layers of lower and higher indices of refraction. For example, an interior layer contacting the textured region of the cover member 440 may have the first index of refraction and may be followed by a layer having the second index of refraction. The exterior layer of the anti-reflection coating may have the first index of refraction or may have the second index of refraction. When the cover member is formed of a silicate glass material, the one or more layers having a first index of refraction may be formed from a silicon oxide (e.g., SiO₂), and the one or more layers having a second of refraction may be formed from a silicon nitride (SiNₓ, e.g., Si₃N₄). An anti-reflection coating comprising a silicon oxide layer as an exterior layer may facilitate adhesion of the anti-smudge coating to the anti-reflection layer. In some embodiments, the exterior layer of the anti-reflection coating may be treated in order to increase adhesion of the anti-smudge coating to the exterior layer. In some embodiments, an ion beam may be used to treat the exterior layer of the anti-reflection coating. In some cases, the ion beam treatment may be limited so as to remove no more than a few nanometers from the exterior layer of the anti-reflection coating and therefore may not significantly modify the texture produced by anti-reflection coating provided over the textured region of the cover member. In other cases, the ion beam treatment may be used to modify this texture.

In some embodiments, the plurality of inorganic layers of the anti-reflection layer includes an interior silicon oxide layer coupled to the cover member, an exterior silicon oxide layer coupled to the anti-smudge coating, and at least one intermediate layer positioned between the interior and the exterior silicon oxide layers and formed from a material having a hardness greater than silicon oxide. For example, the at least one intermediate layer may be a silicon nitride layer. In additional examples of the anti-reflection coating, the anti-reflection coating may alternately or additionally include layers formed from a metal oxide such as a niobium oxide (e.g., Nb₂O₅), titanium oxide (e.g., TiO₂), tantalum oxide (e.g., Ta₂O₅), zirconium oxide (e.g., ZrO₂), or magnesium oxide (e.g., MgO), a metal nitride other than silicon nitride, or an oxynitride such as a silicon oxynitride (e.g., SiOₓN_{y}).

The cover may include a coating comprising a fluorinated material that provides resistance to fingerprints, smudges, and the like. This coating may therefore be referred to herein as an anti-smudge coating. In some embodiments, this coating is oil repellant and may therefore be alternately referred to herein as an oleophobic coating. The anti-smudge coating may define an exterior surface of the textured portion of the cover and may be bonded to an exterior layer of the anti-reflection coating. When the anti-smudge coating defines the exterior surface of the texture, the anti-smudge coating can contribute to the frictional resistance to movement of a stylus tip and/or a user's finger across the surface texture 432.

The fluorinated material of the anti-smudge coating may be a fluorinated polymer or a fluorinated oligomer (e.g., having from 10 to 100 monomeric repeat units). The fluorinated material may be a linear, a branched, or a combination of these. In embodiments, a fluorinated oligomer or polymer molecule may include a functional end group which attaches the fluorinated oligomer or polymer to the anti-reflection coating. By the way of example, the functional group may include a silane group or a hydroxyl group capable of interacting with a surface group of the anti-reflection coating. In some cases, the functional group may form at least one of a covalent bond and a hydrogen bond with the anti-reflection coating. As previously mentioned, in some embodiments, the exterior layer of the anti-reflection coating may be treated in order to increase adhesion between the fluorinated material and the exterior layer of the anti-reflection coating. Alternately or additionally, the anti-smudge coating may be treated to modify its coefficient of friction through a technique such as plasma treatment or the like that modifies one or more of the surface composition, surface roughness, or the length of the fluorinated oligomers or polymers.

FIG. 5 shows an enlarged partial cross-sectional view of a cover for an example electronic device. The cover 520 defines a surface texture 532. The surface texture 532 may be positioned over a display assembly as shown in the partial cross-sectional view of FIG. 4. The view of FIG. 5 may be an enlarged view of detail area 3-3 of FIG. 4.

The surface texture 532 of the cover 520 defines plurality of surface features, such as the peak 533 and the valley 535. A set of surface features of the surface texture 542 may be configured to produce the anti-glare effect. The surface texture 532 of the cover 520 may be defined by the textured region 552 of the cover member 540, the anti-reflection coating 562, and the anti-smudge coating 564. The textured region 552 of the exterior surface 542 of the cover member 540 also defines a plurality of surface features, such as the peak 553 and the valley 555.

As previously discussed, the surface texture 532 of the cover 520 may be configured to provide a balance of optical properties. In embodiments, the optical properties of the textured portion of the cover 520 are also balanced against one or more other properties of the textured portion of the cover 520. These other properties of the textured portion may include, but are not limited to, one or more of compatibility of the surface texture 532 with touch sensing, compatibility of the surface texture 532 with objects that contact the textured portion of the cover 520, or the ability to clean the textured portion of the cover to remove oil and dust. Examples of objects that may contact the textured portion of the cover 520 include, but are not limited to, an electronic stylus configured to provide input to the electronic device; a keyboard that may contact the cover 520 (e.g., when the electronic device is stored), a carrying case, or the like. The electronic stylus may be an active stylus that provides an input to the electronic device while in contact with the cover 520 and in some cases may be capable of providing input to the electronic device even when the electronic stylus does not contact the cover 520. The electronic stylus may have a tip portion formed at least in part of a rigid plastic material rather than a rubbery material. The electronic stylus may provide a touch input to a touch sensitive layer of the display assembly. In some cases, the electronic stylus may transmit information about a condition of a stylus to the electronic device.

In some embodiments, the textured portion of the cover 520 is configured so that it is compatible for use with an electronic stylus in addition to providing anti-glare properties and acceptable levels of readability of graphical output from the display. The optical properties of the textured portion of the cover 520 and the compatibility of the textured portion with the electronic stylus depend at least in part on the surface texture 532. For example, the surface texture 532 may be configured to provide increased frictional resistance to movement of a stylus tip as compared to the frictional resistance provided by a substantially smooth surface texture. The increased frictional resistance may be obtained without causing undue wear of the stylus tip. In some cases, a user holding the electronic stylus may experience a tactile effect resembling that of a stylus moving over paper due at least in part to the surface texture 532. The anti-smudge coating 564 may also contribute to the frictional resistance and the tactile effect as previously described with respect to FIG. 4. The surface texture 532 may be configured so that it can be cleaned to remove oil and dust that may interfere with sensing of touch or stylus input.

In embodiments, the surface texture 532 is configured to produce diffusion of light reflected from the cover 520 in order to produce an anti-glare effect. A surface texture 532 that diffusively reflects light from the cover may favorably increase frictional resistance to stylus tip movement. However, there may be trade-offs that result from using a surface texture that increases the amount of light diffusively reflected from the cover. These trade-offs may include one or more of reduction in the readability of graphic output from the display, faster wear of the stylus tip, or greater difficulty in removing oil, dust, and the like from the surface texture. The readability of graphic output from the display may be characterized by an image sharpness value and/or a sparkle value.

A textured portion of the cover 520 configured to be compatible for use with an electronic stylus in addition to providing anti-glare properties and acceptable levels of readability of graphical output from the display, may be characterized in part by the optical properties of the textured portion. Optical properties that may be used to characterize the anti-glare properties of the include, but are not limited to, the percentage of light that is diffusively reflected from the textured portion and an image sharpness value. For example, the textured portion of the cover 520 may diffusively reflect 15% to 60%, 20% to 55%, or 23% to 50% of the light reflected from the textured portion. In some embodiments, the extent of diffuse reflection is determined from measurements of the intensity of scattered light as function of angle of reflection. In some cases, the extent of diffuse reflection may be determined by comparing the intensity or luminance at a non-zero reflection angle to the intensity or luminance at zero degrees. For example, a diffusion value for reflected light may be determined from the ratio of the sum of the luminance at +0.5 degrees and −0.5 degrees divided by twice the luminance at 0 degrees. The extent of diffuse reflection may be determined using commercially available equipment. In some cases, the commercially available equipment refers to the extent of diffuse reflection as a haze percentage. As a non-limiting example, the extent of diffuse reflection may be determined using a SMS-1000 available from DM&S (Display-Messtechnik & Systeme).

Alternately or additionally, an image sharpness value may be used to provide a measure of diffusion of light transmitted through the cover. For example, the image sharpness value may be quantified by amount of narrow angle scattering, such as the percentage of diffused light within an angle of 2.5 degrees with respect to a normal to the surface of the cover. In some cases, an image sharpness value may be determined from the equation Image Sharpness=M_{AG}/M₀. The image sharpness value in terms of percentages may be calculated by multiplying this ratio by 100%. The value M_{AG} may be a value of the modulation transfer function for a sample having an antiglare texture while the value M₀ may be a value of the modulation transfer function of a reference sample (e.g., a sample having a smooth texture). The modulation transfer function values may depend on the pixel spacing and therefore may be determined for a cover provided over a particular display assembly. As an example, the modulation transfer and image sharpness values may be determined for a cover that is provided over the display assembly of the electronic device. As another example, modulation transfer and image sharpness values may be determined for a cover placed over a reference display assembly that is different than the display assembly of the electronic device. In some cases, the reference display assembly may have a number of pixels per inch that is greater or less than the number of pixels per inch of the display assembly of the device. For example, the reference display assembly may have a number of pixels per inch that differs from the number of pixels per inch of the display assembly of the electronic device by no more than 20%. As a non-limiting example, the extent of image sharpness, alternately referred to as the transmissive distinctness of image, may be measured using a SMS-1000 available from DM&S (Display-Messtechnik & Systeme). Alternately, an image sharpness value based on illumination diffusion analysis may be performed using an imaging transmission appearance meter, such as the instruments available from Rhopoint America Inc., Troy, MI.

Optical properties that relate to the readability of the display assembly through the textured portion of the cover 520 include, but are not limited to, an image sharpness value and a sparkle value. The textured portion of the cover 520 may have an image sharpness value that is greater than 20% and less than 100%, greater than 20% and less than 70%, greater than 20% and less than 60%, or greater than 24% and less than 60%. The amount of sparkle produced by the cover may be less than 10%, less than 8%, less than 6%, less than or equal to 5%, from 2.5% to 7.5%, or from 3% to 6%. The sparkle value may be determined for a cover provided over a particular display assembly. As an example, the sparkle value may be determined for a cover that is provided over the display assembly of the electronic device. As another example, the sparkle value may be determined for a cover placed over a reference display assembly that is different than the display assembly of the electronic device. In some cases, the reference display assembly may have a number of pixels per inch that is greater or less than the number of pixels per inch of the display assembly of the device. For example, the reference display assembly may have a number of pixels per inch that differs from the number of pixels per inch of the display assembly of the electronic device by no more than 20%. The sparkle may be measured based on activation of the green subpixels of the display. As discussed in more detail below, the sparkle effect may be affected by the pixel element configuration of the display assembly and may be more noticeable for smaller subpixel sizes. In some embodiments, the display assembly includes an optical structure that is configured to minimize the sparkling effect and that is positioned between the cover and the pixel elements of the display. The sparkling effect (also referred to herein as sparkling or sparkle) may be measured using commercially available equipment. As a non-limiting example, the sparkle value may be measured using a SMS-1000 available from DM&S. With this device, the sparkle value may be determined from two different images of the pixels of the display, with the sparkle value equal to the standard deviation of the gray-level distribution of the filtered difference image divided by the mean value.

The textured portion of the cover 520 may also be characterized by an optical property that characterizes the uniformity of the surface texture 532. For example, the uniformity of the surface texture 532 may be characterized by illuminating the textured portion of the cover and determining an extent of luminance variation (e.g., a perceived variation in lightness and darkness) of the textured portion of the cover. The luminance variation may be measured using either transmitted or reflected light. In some cases, an image of the textured portion of the cover 520 (or of the textured region of the glass cover member 540) may be obtained using an image sensor (e.g., with a digital camera) and a luminance of each pixel of the image may be determined, thereby allowing determination of a luminance variation across the textured surface. For example, the luminance variation may be characterized by a standard deviation value that is derived from the luminance values. As another example, the luminance variation may be assessed by a perceived grainy effect of the textured portion of the cover. The grainy effect may be determined from a histogram of the lightness values, such as with a BYK-mac device (BYK-Gardner GmbH, Geretsried, Germany).

A textured portion of the cover 520 configured to be compatible for use with an electronic stylus in addition to providing anti-glare properties and acceptable levels of readability of graphical output from the display, may be characterized in part by one or more texture parameters of the textured portion. For example, each of the surface texture 532 of the cover 520 and the textured region 552 of the cover member 540 may be characterized by various surface texture parameters. These surface texture parameters include, but are not limited to, parameters which may be determined according to ISO 25178, ISO 4287, or other established techniques. In some cases, these techniques determine a reference surface, such as the arithmetical mean of the surface. Surface texture parameters that may be determined according to ISO 25178 include, but are not limited to, field parameters such as the root mean square height (Sq), also referred to herein as the root mean square amplitude, and the root mean square of the surface gradient (Sdq) and feature parameters such as the mean peak curvature (Spc) (alternately referred to as the arithmetic mean summit curvature (Ssc)). Additional feature parameters have been established and may be determined by commercially available software such as MountainsMap® software available from Digital Surf, Besançom, France. These additional feature parameters include, but are not limited to, parameters such as the mean spacing (alternately referred to as the pitch), maximum spacing, and minimum spacing of peaks or pits, as well as a mean diameter of hills or dales. Surface texture parameters which may be determined according to ISO 4287 include, but are not limited, to a mean spacing of roughness profile elements Rsm and an arithmetic mean Ra. Alternately or additionally, the surface texture parameters may be feature parameters that are calculated from specific features (e.g., hills or dales) as determined using a segmentation algorithm.

Several properties of the textured region of the cover 520 may be influenced at least in part by two or more of an amplitude parameter, a spacing parameter, and a gradient parameter of the surface texture 532. In some embodiments, the amount of diffusive reflection from the textured portion of the cover 520, the “grippiness” of the surface texture 532, the readability of the display assembly through the textured portion of the cover, and the cleanability of the surface texture may be influenced by two or more of the root mean square height Sq, a mean peak spacing, and a root mean square of the surface gradient Sdq. As an example, a greater root mean square height for a given peak spacing may tend to produce a greater amount of diffusive reflection and “grippiness.” However, a greater root mean square height for a given peak spacing may also tend to decrease the readability of graphical output from the display assembly through the texture and may also tend to make it more difficult to clean oil and dust from the surface texture 532.

In some embodiments, the surface texture is characterized by two or more of the following parameters relating to the amplitude, the spacing, and the gradient. The root mean square height Sq may be in a range from 0.10 micrometers to 0.35 micrometers, from 0.14 micrometers to 0.30 micrometers or from 0.16 micrometers to 0.28 micrometers. The pitch (e.g., the mean peak spacing) may be in a range from 3.5 micrometers to 20 micrometers, from 4 micrometers to 16 micrometers, from 4.5 micrometers to 14 micrometers, or from 4.8 micrometers to 13.3 micrometers. The root mean square of the surface gradient Sdq may be in a range from greater than zero to 0.4, from 0.02 to 0.40, from 0.03 to 0.35, or from 0.04 to 0.33. These examples may apply to a textured region of cover that includes one or more coatings applied to an exterior surface of a cover member.

The compatibility of the textured region of the cover 520 with an electronic stylus or other object may be influenced at least in part by the sharpness of peaks of the surface texture. In some embodiments, the mean peak curvature Spc is in a range from greater than zero to 2.5 micrometers⁻¹, from greater than zero to 2.27 micrometers⁻¹, or from 0.5 micrometers-1 to 1.6 micrometers⁻¹.

In some embodiments, the textured region of the cover member 540 is made by a texturing process that includes a wet grit blasting operation followed by an etching operation. A mask may be used as desired to shield surface regions of the cover member 540 from the texturing process. The wet grit blasting process may form a grit-blasted texture on the surface of the cover member, the grit-blasted texture including small pits and/or fissures formed in the surface of the cover member. In some cases, a lateral dimension of these features is less than 4 micrometers or less than 3 micrometers in size. The wet grit blasting operation may utilize one or more grit blasting nozzles, each of which blasts a greater area of the cover member than some conventional grit blasting nozzles. Therefore, the wet grit blasting operation may produce a grit-blasted texture that is more uniform over the cover member as compared to some conventional grit blasting operations.

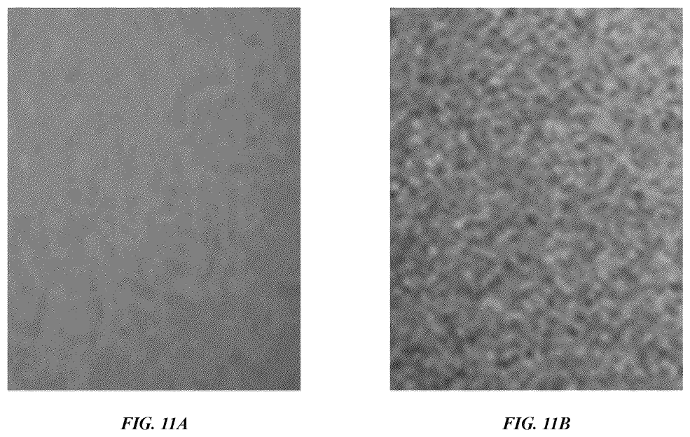

The textured region of the cover member is developed by etching the grit-blasted texture. The etching operation may etch the cover member to a depth greater than the depth of the pits and/or fissures of the grit blasted texture. The etching operation may involve immersing the cover member in a bath including an etchant such as a suitable acid or base. A cover member with a more uniform grit-blasted texture can produce a more uniform textured region after the etching operation, as schematically illustrated by the example of FIG. 11A.

FIG. 6 shows another partial cross-sectional view of an example electronic device. The electronic device 600 includes a cover 620. As shown in FIG. 6, a portion 625 of the cover 620 defines a substantially smooth surface texture 634 at an exterior surface 622 of the cover. The surface texture 634 may provide a glossy rather than an anti-glare effect. The portion 625 of the cover 620 may extend from an exterior surface 622 to an interior surface of the cover. The view of FIG. 6 may be an example of a cross-sectional view along A-A at detail 2-2 of FIG. 1.

In the example of FIG. 6, the portion 625 of the cover 620 includes a cover member 640 and a surface coating 660 disposed over the cover member 640. Since the surface texture 634 of the portion 625 is substantially smooth, the portion 625 of the cover 620 may produce a lesser amount of diffusely reflected light than the anti-glare portion of the cover. For example, the portion 625 of the cover 620 may provide a glossy effect. The surface texture 654 of the cover member 640 is also substantially smooth and may be a polished texture. The surface texture 654 and the surface coating 660 may together define the surface texture 634 of the cover 620. The surface coating 660 may include an anti-reflection coating and/or an anti-smudge coating. These coatings may be similar in composition and function to the anti-reflection and the anti-smudge coatings described with respect to FIG. 5 and that description is not repeated here.

Each of the surface texture 634 of the cover 620 and the textured region 654 of the cover member 640 may be characterized by one or more texture parameters. However, the root mean square height Sq and the root mean square of the surface gradient Sdq of the surface texture 634 of the portion 625 is typically smaller than the root mean square height and the root mean square gradient of the surface texture that is configured to produce anti-glare effect. For example, the root mean square height Sq of the surface texture 634 may be less than 100 nanometers, less than 75 nanometers, or less than 50 nanometers. The description of texture parameters provided with respect to FIG. 5 is generally applicable herein and is not repeated here. The textured region 654 may alternately be referred to as defining a surface finish of the exterior surface 642 and in some embodiments may be referred to as a second region of the cover member.

In the example of FIG. 6, the cover 620 is positioned over the sensor assembly 682. The cover 620 also includes an interior coating 627 disposed over an interior surface 644 of the cover member 640. The interior coating 627 defines an opening 628 that is positioned over the sensor assembly 682. With the exception of openings provided over optical components such as the sensor assembly 682, the interior coating 627 may mask the interior of the electronic device 600 from view through the cover member 640 in the portion 625 of the cover 620. In some embodiments, the interior coating 627 may also be disposed over a relatively small region of an interior surface of the cover member 640 in an anti-glare portion of the cover (e.g., a peripheral region of the portion 123 of FIG. 1). For example, a portion of the interior coating 627 may extend a distance that is greater than or equal to 100 micrometers and less than or equal to 1 millimeter or greater than or equal to 100 micrometers and less than or equal to 200 micrometers along the interior surface of the cover member 640 in the anti-glare portion of the cover 620. This portion of the interior coating 627 may limit or prevent light entering or leaving the textured portion of the cover 620 from undesirably influencing the sensor assembly 682 and/or other sensor assemblies of the electronic device. This portion of the interior coating may extend around the display assembly.

FIG. 7 shows another partial cross-sectional view of an example electronic device. The electronic device 700 includes a display assembly 770 and a cover 720 positioned over the display assembly. The view of FIG. 7 may be an example of a cross-sectional view along A-A at detail 1-1 of FIG. 1 and may be an example of detail area 4-4 of FIG. 4.

As shown in FIG. 7, a textured portion 723 of the cover 720 defines a surface texture 732. The surface texture 732 may provide an anti-glare effect. The surface texture 732 may have similar properties as the surface textures 432 and 532. The cover member 740 and the surface coating 760 and its components may be similar in composition and function to the cover members 440 and 540 and the surface coatings 460, 562, and 564.

The display assembly 770 includes multiple components. In the simplified view of FIG. 7, the display 770 includes a set of display layers 772, a touch-sensitive component 774, an optical structure 776, and a set of intermediate layers 778. The example of FIG. 7 is not intended to be limiting and in other examples the display assembly may omit one of these components, additional components may be present in the display assembly, and/or the components of the display assembly may be arranged in a different order than is shown in FIG. 7.

The display assembly 770 includes a set of display layers 772. The set of display layers may define an array of pixel elements and each pixel element of the array of pixel elements may include a set of subpixels. In some cases, the number of pixels per inch may be from 225 pixels per inch to 275 pixels per inch or from 250 pixels per inch to 270 pixels per inch. In other cases, the number of pixels per inch may be on the order of 425 pixels per inch to 470 pixels per inch. In some examples, a device with an 11-inch screen size may have from 2350 pixels to 2550 pixels or from 2375 pixels to 2575 pixels in the width dimension and from 1550 pixels to 1750 pixels or from 1575 pixels to 1775 pixels in the height dimension. In some examples, a device with a 13-inch screen size may have from 2650 pixels to 2850 pixels or from 2675 pixels to 2875 pixels in the width dimension and from 1950 pixels to 2150 pixels or from 1975 pixels to 2175 pixels in the height dimension. The screen size may be measured across a diagonal of the display. Examples of pixel element and subpixel configurations are shown in FIGS. 8A and 8B and the description provided with respect to these figures, as well the additional pixel-related description provided with respect to FIGS. 9 and 10, is not repeated here. The display assembly 770 also typically includes electronic circuitry operably connected to the pixel elements of the array, as previously discussed with respect to FIG. 4.

The display assembly 770 further includes a touch-sensitive component 774. The touch-sensitive component may comprise a touch sensor configured to detect a touch or touch input along an exterior surface of the cover 720. The touch-sensitive component 774 is positioned between the cover member 740 and the set of display layers 772. In some embodiments, the touch sensitive component 774 may be adhesively coupled to the cover member 740. The touch sensitive component 774 may rely on an electric field sensing technique. In some examples, the electric field sensing technique may be a capacitive sensing technique. The touch-sensitive component may be configured to detect input from a finger and an active stylus. This input may include a finger touch and an active stylus touch. In some cases, the touch-sensitive component may include a first set of sensors that are used to detect input from a user's finger, such as a finger touch, and a second set of sensors that are used to detect input from an active stylus, such as a touch from the active stylus. In other cases, the touch-sensitive component may employ multiplexing to allow use at least some of the same sensors to detect both finger input and active stylus input.

The display assembly 770 includes an optical structure 776. The optical structure 776 is positioned between the cover member 740 and the set of display layers 772. In the example of FIG. 7, the optical structure 776 is shown as positioned between the touch-sensitive component 774 and the set of display layers 772, but this example is not limiting and in other examples, the optical structure 776 may be positioned between the cover member 740 and the touch-sensitive component. The optical structure 776 may be configured to reduce sparkling effects due to the surface texture 732.

In some examples, the optical structure 776 is configured to enlarge an optical output of at least one subpixel of the array of pixel elements, as schematically shown in the example of FIG. 10. Stated differently, a subpixel of the array of pixel elements may emit light over a first area; and light emitted from the subpixel and exiting the optical structure may span a second area greater than the first area. The enlargement of the optical output of the subpixel(s) may be due at least in part to a refractive effect. Such an optical structure can help reduce sparkling effects when a lateral dimension (e.g., a width and/or a length) of one or more subpixels is similar to a mean spacing of peaks of the surface texture. In other examples, the optical structure 776 may produce a diffractive effect in order to help reduce sparkling effects. The example of FIG. 7 is not intended to be limiting and in other examples the display assembly 770 need not include an optical structure 776.

The display assembly 770 also includes at least one intermediate layer 778. The intermediate layer 778 is positioned between the cover member 740 and the set of display layers 772. In some embodiments, the at least one intermediate layer 778 includes a shielding layer that limits the effect of the electronic circuitry of the display layers on other components of the display assembly such as the touch-sensitive layer and/or on operation of an electronic stylus. The shielding layer may include a conductive layer and, in some cases, may include a layer of indium tin oxide. In the example of FIG. 7, the at least one intermediate layer is positioned between the optical structure 776 and the set of display layers 772, but this example is not intended to be limiting and other positions of the at least one intermediate layer(s) may provide the desired function of the layer, such as a shielding function.

FIG. 8A shows a top view of a pixel element including a set of subpixels. The pixel element 802 includes a set of subpixels 810. In the example of FIG. 8A, the subpixels 812, 814, and 816 all have substantially the same width and height. The subpixels 812, 814, and 816 may have different colors, such as red, green, and blue. When the set of subpixels 810 is viewed through a textured cover, sparkling effects may occur when a lateral dimension (e.g., a width and/or a length) of the subpixels is similar to a mean spacing of peaks of the surface texture of the cover.

FIG. 8B shows another top view of pixel element including a set of subpixels. The pixel element 804 includes a set of subpixels 820. In the example of FIG. 8B, the subpixels 822, 824, and 826 differ in their lateral dimensions such as width and height. In some embodiments, at least one subpixel of the array of pixel elements has a minimum lateral dimension in a range from 10 micrometers to 20 micrometers or that is less than or equal to 30 micrometers or less than or equal to 25 micrometers. The subpixels 822, 824, and 826 may have different colors, such as red, green, and blue. In some embodiments, the smallest subpixel 824 is a red subpixel. When the set of subpixels 820 is viewed through a textured cover, sparkling effects may occur when a lateral dimension (e.g., a width and/or a length) of one or more subpixels is similar to a mean spacing of peaks of the surface texture. Because the subpixels 822, 824, and 826 vary in size, the sparkling effect may be different for the different subpixels of the array, with a greater amount of sparkling for the smaller subpixels 824. The examples of the relative sizes and numbers of subpixels shown in FIGS. 8A and 8B are not intended to be limiting and in other examples the relative sizes and/or number of subpixels may be different.

FIG. 9 shows a simplified example of passage of light from pixel elements of a display assembly 970 into textured cover 920 of an electronic device 900. The textured cover 920 defines a surface texture 932. The display assembly 970 includes display layers 972 that define pixel elements 912 and 914. The display assembly 970 also includes layers 980 between the display layers 972 and the cover member 940. These layers 980 may include a touch-sensitive component, a shielding component, and the like as previously discussed with respect to FIG. 7.

FIG. 9 illustrates that the light 992a and 994a is emitted from the pixel elements 912 and 914, respectively. The simplified view of FIG. 9 illustrates that the light 992a and 994a is emitted over a region of each of the pixel elements 912 and 914 that is small relative to the width of features of the surface texture 932 and the spacing between adjacent peaks of the features in the plane of the cross-section. The small size of the region over which light is emitted is exaggerated for purposes of illustration in FIG. 9. In some examples, the light 992a and 994a may be emitted from subpixels that have a lateral dimension that is similar to the spacing between some of the adjacent peaks of features of the surface texture.

The light 992a and 994a passes through a set of layers 980 of display assembly 970 and continues through the cover 920 as light 992b and 994b. The width of light 992b and 994b is similar to that of the light 992a and 994a (in the cross-sectional view).

The surface texture 932 may lead to redirection of some of the light passing through the surface texture 932. For convenience of illustration, the details of redirection of light by the surface texture 932 is not shown in FIG. 9. In some cases, the redirection of the light by the surface texture 932 may lead to a sparkling effect. The example of FIG. 9 has been simplified for purposes of illustration and for comparison with the example of FIG. 10 and therefore is not intended to be limiting.

FIG. 10 shows another simplified example of passage of light from pixel elements of a display assembly 1070 through a textured cover 1020 of an electronic device 1000. The textured cover 1020 defines a surface texture 1032. The display assembly 1070 includes display layers 1072 that define pixel elements 1012 and 1014. The display assembly 1070 also includes layers 1080 between the display layers 1072 and the cover member 1040. In contrast to the example of FIG. 9, the layers 1080 include an optical structure 1088 that “spreads out” the light 1092a, 1094a emitted from the pixel elements 1012 and 1014. The small size of the region over which light is emitted is exaggerated for purposes of illustration in FIG. 10. The layers 1080 also include the layers 1082 and 1084, which may include a touch-sensitive component, a shielding layer, and the like as previously discussed with respect to FIG. 7.

FIG. 10 shows a cross-sectional view of the light 1092a and 1094a passing through the layer 1082 and entering the optical structure 1088. The region over which light 1092b and 1094b exits the optical structure 1088 is larger than the region over which the light 1092a and 1094a enters the optical structure. Therefore, the area over which the light from the pixel elements exits the optical structure is expanded as compared to the area over which light from the pixel elements enters the optical structure 1088. In the example of FIG. 10, the optical structure 1088 includes a plurality of beads 1089. The plurality of beads 1089 may define a layer. In some embodiments, the beads 1089 refract light as it moves through the optical structure 1088. For convenience of illustration, the details of passage of the light through the optical structure 1088 (e.g., through the beads 1089) is not shown in FIG. 10. In some embodiments, the beads have a size (e.g., a diameter) that is less than a minimum lateral dimension of the subpixel. Each of the beads may have a size that is less than the minimum lateral dimension of the subpixel. The spacing between the beads need not be uniform, as schematically illustrated in FIG. 10. In some examples, the beads may be randomly spaced within the layer. The layer may also comprise a polymer material and the beads distributed within the polymer material. The example of FIG. 10 is not limiting and in other examples the optical structure 1088 may have different construction but still produce a suitable optical effect.

The light 1092b and 1094b passes through the layer 1084 and then passes through the cover as light 1092c and 1094c. The surface texture 1032 may lead to redirection of some of the light passing through the cover 1020. For convenience of illustration, the details of redirection of light by the surface texture 1032 is not shown in FIG. 10. However, the optical structure 1088 may produce a more favorable angular distribution of the light exiting the cover 1020 as compared to the cover 920. In some embodiments, an optical structure similar to the optical structure 1088 can reduce the amount of sparkle.

FIG. 11A shows an example image of luminance of a textured cover of an electronic device. In the example of FIG. 11A, the luminance distribution is sufficiently uniform that any grainy effect of textured cover is limited. The textured cover of FIG. 11A produces optical properties suitable for use over a display including pixel elements (e.g., subpixels) having a minimum lateral dimension in a range from 10 micrometers to 20 micrometers. The textured cover of FIG. 11A may be produced by the methods previously discussed with respect to FIG. 5.

FIG. 11B shows an example image of light transmitted through a textured cover of an electronic device. In contrast to the example of FIG. 11A, the luminance distribution is less uniform and produces a greater grainy effect. The textured cover of FIG. 11B may be produced by conventional texturing methods.

FIG. 12 shows an example block diagram of components of an electronic device. The electronic device 1200 can incorporate an enclosure having a textured cover as described herein. The schematic representation of FIG. 12 may correspond to components of the devices depicted in FIGS. 1, 2A-2B, and 3 as described above. However, FIG. 12 may also more generally represent other types of electronic devices including an enclosure having a textured cover as described herein.

In embodiments, an electronic device 1200 may include a display 1202. The display 1202 may include a liquid-crystal display (LCD), a light-emitting diode (LED) display, an LED-backlit LCD display, an organic light-emitting diode (OLED) display, an active layer organic light-emitting diode (AMOLED) display, an organic electroluminescent (EL) display, an electrophoretic ink display, or the like. If the display 1202 is a liquid-crystal display or an electrophoretic ink display, the display 1202 may also include a backlight component that can be controlled to provide variable levels of display brightness. If the display 1202 is an organic light-emitting diode or an organic electroluminescent-type display, the brightness of the display 1202 may be controlled by modifying the electrical signals that are provided to display elements. In addition, information regarding configuration and/or orientation of the electronic device may be used to control the output of the display as described with respect to input devices 1212. In some cases, the display is integrated with a touch and/or force sensor in order to detect touches and/or forces applied along an exterior surface of the device 1200.

The device 1200 also includes a processor 1204. The processor 1204 may be operably connected with a computer-readable memory 1208. The processor 1204 may be operatively connected to the memory 1208 component via an electronic bus or bridge. The processor 1204 may be implemented as one or more computer processors or microcontrollers configured to perform operations in response to computer-readable instructions. The processor 1204 may include a central processing unit (CPU) of the device 1200. Additionally, and/or alternatively, the processor 1204 may include other electronic circuitry within the device 1200 including application specific integrated chips (ASIC) and other microcontroller devices. The processor 1204 may be configured to perform functionality described in the examples above.

The device 1200 also includes a power source 1206. In some embodiments, the power source includes a battery that is configured to provide electrical power to the components of the electronic device 1200. The battery may include one or more power storage cells that are linked together to provide an internal supply of electrical power. The battery may be operatively coupled to power management circuitry that is configured to provide appropriate voltage and power levels for individual components or groups of components within the electronic device 1200. The battery, via power management circuitry, may be configured to receive power from an external source, such as an alternating current power outlet. The battery may store received power so that the electronic device 1200 may operate without connection to an external power source for an extended period of time, which may range from several hours to several days.

The memory 1208 may include a variety of types of non-transitory computer-readable storage media, including, for example, read access memory (RAM), read-only memory (ROM), erasable programmable memory (e.g., EPROM and EEPROM), or flash memory. The memory 1208 is configured to store computer-readable instructions, sensor values, and other persistent software elements.

The device 1200 also includes a sensor system 1210. The sensor system 1210 may include one or more sensors or sensor components, such as a force sensor, a capacitive sensor, an accelerometer, a barometer, a gyroscope, a proximity sensor, a light sensor, a microphone, an acoustic sensor, a light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, a pulse oximeter, a biometric sensor (e.g., a fingerprint sensor), or other types of sensing device. In some cases, the device 1200 includes a sensor array (also referred to as a sensing array) which includes multiple sensors. For example, a sensor array may include an ambient light sensor, a Lidar sensor, and a microphone. In additional examples, one or more camera components may also be associated with the sensor array. The sensor system 1210 may be operably coupled to processing circuitry. In some embodiments, the sensors may detect deformation and/or changes in configuration of the electronic device and be operably coupled to processing circuitry that controls the display based on the sensor signals. In some implementations, output from the sensor system is used to reconfigure the display output to correspond to an orientation or folded/unfolded configuration or state of the device. Example sensors for this purpose include accelerometers, gyroscopes, magnetometers, and other similar types of position/orientation sensing devices.

The input/output mechanism 1212 may include one or more input devices and one or more output devices. The input device(s) are devices that are configured to receive input from a user or the environment. An input device may include, for example, a push button, a touch-activated button, a capacitive touch sensor, a touch screen (e.g., a touch-sensitive display or a force-sensitive display), a capacitive touch button, dial, crown, or the like. In some embodiments, an input device may provide a dedicated or primary function, including, for example, a power button, volume buttons, home buttons, scroll wheels, and camera buttons. The one or more output devices include the display 1202 that renders visual information, which may be generated by the processor 1204. The one or more output devices may also include one or more speakers to provide audio output and/or one or more haptic devices that are configured to produce a haptic or tactile output along an exterior surface of the device 1200. The input/output mechanism may also include a communication port or a communication channel. A communication channel may include one or more wireless interface(s) that are adapted to provide communication between the processor 1204 and an external device, one or more antennas (e.g., antennas that include or use housing components as radiating members), communications circuitry, firmware, software, or any other components or systems that facilitate wireless communications with other devices.

The electronic device 1200 also includes a system 1214 in communication with the elements 1202, 1204, 1206, 1208, 1210, and 1212. In some examples, the system 1214 includes circuitry, such as electronic buses and/or bridges. The system 1214 may also include application specific integrated chips (ASIC) and other microcontroller devices.

As used herein, use of the term “about” in reference to the endpoint of a range may signify a variation of +/−5%, +/−2%, or +/−1% of the endpoint value. In addition, disclosure of a range in which at least one endpoint is described as being “about” a specified value includes disclosure of the range in which the endpoint is equal to the specified value.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device comprising:
a housing;
a display assembly positioned at least partially within the housing and comprising:
an array of pixel elements; and
a sparkle reduction structure; and
a cover coupled to the housing and comprising:
a cover member defining a textured region positioned over the display assembly;
a multilayer anti-reflection coating disposed over the textured region of the cover member; and
an oleophobic coating bonded to the multilayer anti-reflection coating, the cover configured to produce diffusion of reflected light and a sparkle value of less than 10% for transmitted light.

2. The electronic device of claim 1, wherein the cover defines a surface texture configured to produce from 20% to 55% diffusion of the reflected light and having:
a mean peak spacing in a range from 4 micrometers to 16 micrometers; and
a root mean square gradient (Sdq) in a range from 0.02 to 0.40.

3. The electronic device of claim 2, wherein:
each pixel element of the array of pixel elements comprises a respective set of subpixels; and
the sparkle reduction structure is configured to enlarge an optical output of at least one subpixel of the array of pixel elements.

4. The electronic device of claim 3, wherein the at least one subpixel of the array of pixel elements has a minimum lateral dimension in a range from 10 micrometers to 20 micrometers.

5. The electronic device of claim 4, wherein:
at least one of the sets of subpixels comprises a first subpixel, a second subpixel, and a third subpixel;
the first subpixel defines the minimum lateral dimension and produces red light; and
the second subpixel defines a lateral dimension that is greater than the minimum lateral dimension and produces green light.

6. The electronic device of claim 4, wherein the sparkle reduction structure comprises a layer of beads having a diameter that is less than the minimum lateral dimension of the at least one subpixel of the array of pixel elements.

7. The electronic device of claim 6, wherein the beads are randomly spaced within the layer of beads.

8. An electronic device comprising:
a housing;
a display assembly comprising a touch-sensitive component configured to detect a finger touch and an active stylus touch; and
a cover configured to provide an anti-glare effect and comprising:
a cover member defining a textured region positioned over the display assembly and contributing to the anti-glare effect;
an anti-reflection coating disposed over the textured region of the cover member; and
an oleophobic coating disposed over the anti-reflection coating.

9. The electronic device of claim 8, wherein the cover defines a set of surface features configured to produce the anti-glare effect, the surface features having:
a root mean square height (Sq) in a range from 0.14 micrometers to 0.30 micrometers;
a mean peak spacing in a range from 4 micrometers to 16 micrometers; and
a mean peak curvature (Spc) in a range from greater than zero to 2.5 micrometers⁻¹.

10. The electronic device of claim 9, wherein:
the cover member is formed of a silicate glass;
the anti-reflection coating comprises a plurality of inorganic layers; and
the plurality of inorganic layers includes an interior silicon oxide layer coupled to the cover member, an exterior silicon oxide layer coupled to the oleophobic coating, and at least one intermediate layer positioned between the interior and the exterior silicon oxide layers and formed from a material having a hardness greater than silicon oxide.

11. The electronic device of claim 10, wherein the exterior silicon oxide layer is ion-treated to enhance bonding of the oleophobic coating.

12. The electronic device of claim 8, further including a sensor assembly positioned within the housing, wherein:
the textured region of the cover member is a first region of the cover member;
the cover member further defines a second region having a polished texture;
a first portion of the cover produces from 20% to 55% diffusion of light reflected from the cover and comprises the first region of the cover member, a first region of the anti-reflection coating, and a first region of the oleophobic coating; and
a second portion of the cover is positioned over the sensor assembly and produces a lower diffusion of light reflected from the cover than the first portion, the second portion of the cover comprising the second region of the cover member, a second region of the anti-reflection coating, and a second region of the oleophobic coating.

13. The electronic device of claim 12, wherein:
the second portion of the cover further comprises an interior coating coupled to an interior surface of the cover member and defining an opening positioned over the sensor assembly; and
a peripheral region of the first portion of the cover includes the interior coating along the interior surface.

14. The electronic device of claim 8, wherein the display assembly further comprises:
an array of pixel elements; and
a shielding layer positioned between the array of pixel elements and the touch-sensitive component.

15. An electronic device comprising:
a display assembly comprising an array of pixel elements;
a camera assembly; and
a cover comprising a cover member, an anti-reflection coating disposed over the cover member, and an oleophobic coating disposed over the anti-reflection coating, the cover further comprising:
a first portion defining a first surface texture positioned over the display assembly, the first portion comprising a first region of the cover member, a first region of the anti-reflection coating, and a first region of the oleophobic coating, the first surface texture having:
a first root mean square height (Sq) in a range from 0.14 micrometers to 0.30 micrometers; and
a root mean square gradient (Sdq) in a range from a range from 0.02 to 0.40, the electronic device having an image sharpness value greater than 20% and less than 70% as measured through the first surface texture; and
a second portion of the cover at least partially surrounding the first portion of the cover, positioned over the camera assembly, and defining a second surface texture having a second root mean square height less than the first root mean square height, the second portion of the cover comprising a second region of the cover member, a second region of the anti-reflection coating, and a second region of the oleophobic coating.

16. The electronic device of claim 15, wherein:
the first surface texture has a mean peak spacing in a range from 4.0 micrometers to 16 micrometers; and
20% to 55% of light reflected from the first surface texture is diffusely reflected.

17. The electronic device of claim 16, wherein the cover produces a sparkle value less than 10% as measured through the first surface texture.

18. The electronic device of claim 15, wherein the array of pixel elements comprises subpixels having a minimum lateral dimension that is less than or equal to 25 micrometers.

19. The electronic device of claim 15, wherein the second portion of the cover fully surrounds the first portion of the cover.

20. The electronic device of claim 15, wherein:
the cover member is formed from single piece of glass; and
a surface finish of the first region of the cover member is rougher than a surface finish of the second region of the cover member.
